(19) United States
(12) Patent Application Publication
(10) Pub. No.: US 2018/0041507 A1
(43) Pub. Date: Feb. 8, 2018

(54) System and methods for provisioning devices

(71) Applicant: Hubble Connected India Private Limited, Bangalore (IN)

(72) Inventors: Perumal Raj Sivarajan, Bangalore (IN); Ochintya Sharma, Bangalore (IN); Subramanian Ramakrishnan, Bangalore (IN)

(73) Assignee: Hubble Connected India Private Limited, Bangalore (IN)

(21) Appl. No.: 15/392,864

(22) Filed: Dec. 28, 2016

(30) Foreign Application Priority Data
Aug. 5, 2016 (IN) 201641026866

(51) Int. Cl. H04L 29/06; H04L 9/32; H04L 9/30; H04L 9/08; H04W 12/04; H04W 12/06

(52) U.S. Cl. CPC H04L 63/0869; H04W 12/04; H04W 12/06; H04L 63/062; H04L 9/3066; H04L 9/0841; H04L 9/3249; H04L 9/0869; H04L 9/0863; H04L 63/20; G06F 2221/2111

(57) ABSTRACT

System and methods for provisioning devices. Embodiments disclosed herein relate to headless devices, and more particularly to provisioning connectivity for headless devices. Embodiments herein disclose methods and systems for provisioning headless devices. Embodiments herein disclose methods and systems for provisioning headless devices using a provisioning server.

### CROSS REFERENCE TO RELATED APPLICATIONS

This application is based on and derives the benefit of Indian Non Provisional Application 201641026866 filed on 5^{th} Aug. 2016, the contents of which are incorporated herein by reference.

### Technical Field

Embodiments disclosed herein relate to headless devices, and more particularly to provisioning connectivity for headless devices.

### Background

Currently, pluralities of devices are available which can use communication protocols (such as Wi-Fi, Bluetooth, ZigBee, NFC (Near Field Communication), and so on) to exchange information and/or instructions with at least one other external entity. Such devices need to be provisioned to enable the communication. However, provisioning on headless devices can be difficult due to the absence of adequate interfaces available on the headless devices, such as displays, keyboards, and so on.

An existing solution uses a key associated with the device and made available to a user of the device, such that the user can use the key to connect to a wireless communication network. This solution relies on public key algorithm (such as Diffie-Hellman or other such as RSA and so on), which may not be optimal for headless devices. In another existing method, a key is typically made available to the user by printing/sticking the key to the device or the package. However, this can result in the key being visible to anyone who can physically access the device. If the key is present on the package, the user will have to preserve the package and/or write down the key in a secure and easy to remember location. Other existing methods use options like infrared or NFC to transmit keys is relatively secure (compared to printing password on package) but it is likely to increase cost of sensor/device.

A current standard approach referred to as WPS (Wi-Fi Protected Setup) is an industry standard for provisioning headless devices and it supports two methods of provisioning. One method used by WPS, Personal Identification Number (PIN), a PIN is printed on a sticker on Access Point (AP). The user reads the PIN and types it using a keypad on the other device. However, this method allows brute force attack to expose the network password within a short span of time. In the WPS Push-Button-Connect (PBC) method, the user pushes button on both the AP and provisioned device. Once the button on AP is pushed, WPS-enabled devices can freely join the network for the period of 2 minutes. However, this method requires the user to have physical access to the AP and there is also a lack of security. Wi-Fi WPS is not considered as secure method.

### OBJECTS

The principal object of embodiments disclosed herein is to provide methods and systems for provisioning headless devices using a provisioning server.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a system for provisioning an un-provisioned device, according to embodiments as disclosed herein;

FIG. 2 is a flowchart depicting the process of provisioning an un-provisioned device with a Device Key (DK), according to embodiments as disclosed herein;

FIGS. 3a and 3b are flowcharts depicting the process of provisioning the DK, according to embodiments as disclosed herein;

FIG. 4 is a sequence diagram showing the process of provisioning the DK, according to embodiments as disclosed herein;

FIG. 5 is a sequence diagram showing the process of provisioning the DK, according to embodiments as disclosed herein;

FIGS. 6a, 6b, and 6c are flowcharts depicting the process of provisioning the un-provisioned device, according to embodiments as disclosed herein;

FIGS. 7a and 7b are sequence diagrams depicting the process of provisioning the un-provisioned device, according to embodiments as disclosed herein;

FIG. 8 depicts the key provisioning tool, according to embodiments as disclosed herein;

FIG. 9 depicts the un-provisioned device, according to embodiments as disclosed herein;

FIG. 10 depicts the provisioning device, according to embodiments as disclosed herein; and

FIG. 11 depicts the provisioning server, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

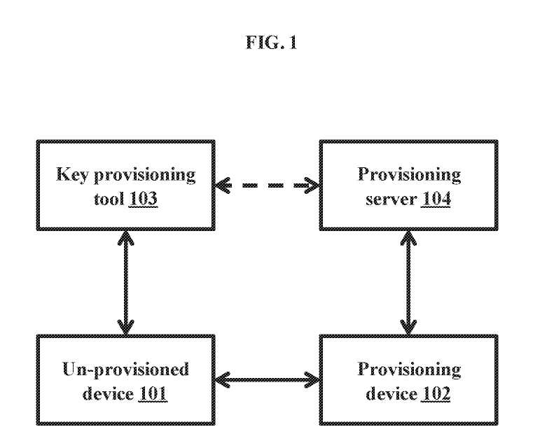

The embodiments herein provide methods and systems for provisioning headless devices. Referring now to the drawings, and more particularly to FIGS. 1 through 11, where similar reference characters denote corresponding features consistently throughout the figures, there are shown preferred embodiments.

An un-provisioned device as referred to herein is a device that has to be provisioned with necessary credentials, configuration, language packs, information, keys so that it can connect to at least one network and perform activities it is built for. For example, IoT (Internet of Things)/connected devices, Wi-Fi/network connected cameras, and so on. In an embodiment, the un-provisioned device can be a headless device. A headless device is a device that operates without a display, graphical user interface (GUI) or peripheral devices, such as keyboard, mouse, and so on.

Language packs can comprise of a set of pre-programmed voice instructions, which enable the device to communicate instructions for various device operations (such as device is in provisioning mode, ready for provisioning, setup instructions, operation/setup success, and so on). The language packs can be created and customized by an authorized user and/or entity. The customized language pack comprises of user recorded or selected collection of voice instructions for various device operations, instead of pre-recorded voice instructions. The pre-recorded or customized language pack can be sent to the device before provisioning, right after provisioning or at any time.

FIG. 1 depicts a system for provisioning an un-provisioned device. The un-provisioned device 101 can communicate with the provisioning device 102 using a suitable communication means such as a wired and/or wireless means. The provisioning device 102 can comprise of an application that facilitates provisioning of the un-provisioned device 101. The application can enable the provisioning device 102 to interact with the user and other entities (if required). The provisioning device 102 can access information such as device details and so on that are used during provisioning processes. This information can be stored on the provisioning device 102, or in a location that the provisioning device 102 can access, such as a provisioning server 104, another server, a database, the Cloud, and so on.

The un-provisioned device 101 can be connected to a key provisioning tool 103. The un-provisioned device 101 can communicate with the key provisioning tool 103 using a suitable communication means such as a wired and/or wireless means. The key provisioning tool 103 can be a secure system. The connection between the un-provisioned device 101 and the key provisioning tool 103 can be a secure connection in a secure environment. If the connection between the un-provisioned device 101 and the key provisioning tool 103 is a wired connection, physical security of the connection is enforced. If the connection between the un-provisioned device 101 and the key provisioning tool 103 is a wireless link, the link is a secure link such as has enough obstructions (such as walls, jammers) that ensures wireless signals do not stray. The key provisioning tool 103 provisions the device key (DK) on the un-provisioned device 101. The key provisioning tool 103 can also provision other relevant parameters on the un-provisioned device 101 such as device unique identifier, device MAC (Media Access Control) id and other relevant configuration parameters.

The provisioning device 102 can be connected to a provisioning server 104. The provisioning device 102 can communicate with the provisioning server 104 using a suitable communication means such as a wired and/or wireless means. The provisioning server 104 can comprise of device details, device key(s) that are used during provisioning processes, and other related information. The provisioning server 104 can receive the un-provisioned device related details from the key provisioning tool 103.

The un-provisioned device 101 can communicate with the provisioning server 104 directly or through the provisioning device 102 where the provisioning device 102 acts as proxy.

In an embodiment herein, the un-provisioned device 101 can be connected to multiple provisioning devices 102 simultaneously. In an embodiment herein, the provisioning device 102 can be connected to multiple un-provisioned devices 101 simultaneously.

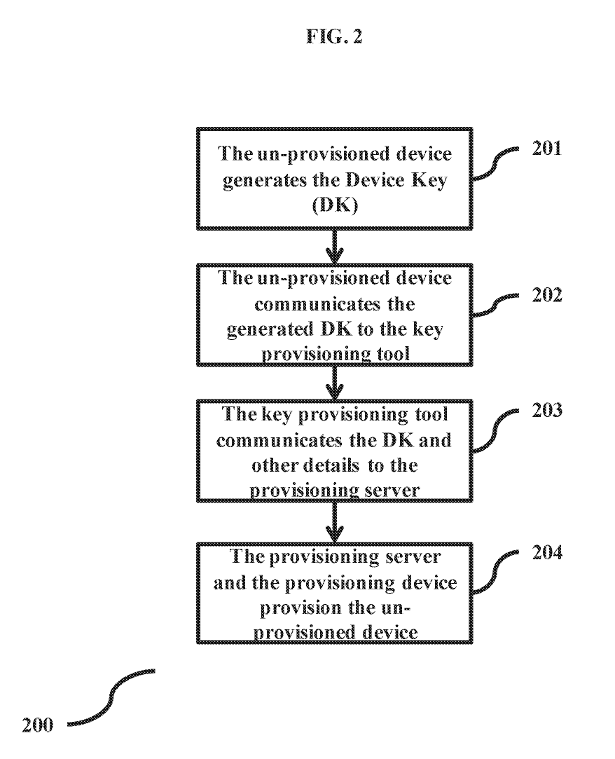

FIG. 2 is a flowchart depicting the process of provisioning an un-provisioned device with a Device Key (DK). In step 201, the un-provisioned device 101 generates the DK. DK can be at least one of a symmetric key or an asymmetric key. The methods explained in this document assume that DK is a symmetric key. In step 202, the un-provisioned device 101 communicates the generated DK to the key provisioning tool 103. The un-provisioned device 101 can communicate the DK to the key provisioning tool 103 using the secure connection present between them. In step 203, the key provisioning tool 103 communicates the DK to the provisioning server 104. The key provisioning tool 103 also communicates other details such as device unique identifier, device MAC (Media Access Control) identifier and other relevant configuration parameters to the provisioning server 104. In step 204, the provisioning server 104 and the provisioning device 102 provision the un-provisioned device 101. The various actions in method 200 may be performed in the order presented, in a different order or simultaneously. Further, in some embodiments, some actions listed in FIG. 2 may be omitted.

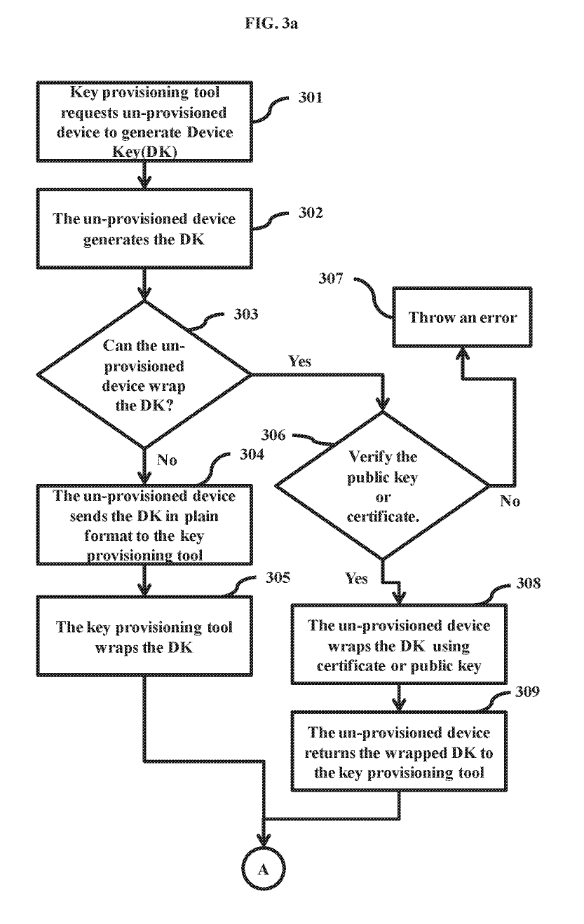

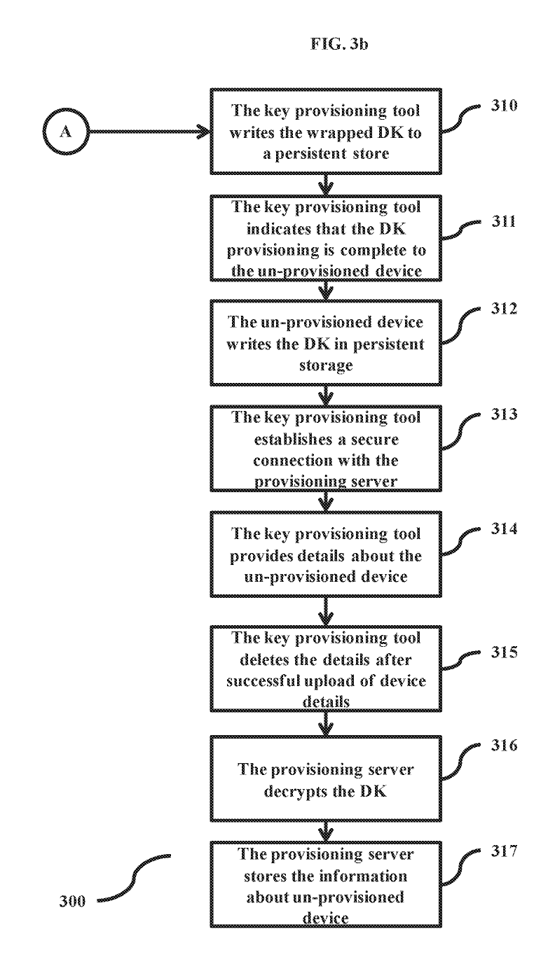

FIGS. 3a and 3b are flowcharts depicting the process of provisioning the DK. In step 301, the key provisioning tool 103 sends a request to generate the DK to the un-provisioned device 101. The request can also comprise of the public key or certificate that has to be used to wrap the DK. The public key or the certificate to be used can depend on the capability of the un-provisioned device 101. The provisioning server 104 comprises of the private key that corresponds to the public key or certificate. In step 302, the un-provisioned device 101 generates the DK, on receiving the request from the key provisioning tool 103. DK may be at least one of a symmetric key (which can be a random value) or an asymmetric key. In step 303, the un-provisioned device 101 checks if the un-provisioned device 101 can wrap the DK using at least one of a certificate or a public key. In step 304, if the un-provisioned device 101 is not capable wrapping the DK (which can be due to at least one of a hardware or a software limitation/issue), the un-provisioned device 101 sends the DK in plain format to the key provisioning tool 103. In step 305, on receiving the DK in plain format, the key provisioning tool 103 wraps the DK using public key/certificate (after performing necessary validation of the public key or certificate). In step 306, if the un-provisioned device 101 is capable of performing wrapping operation, the un-provisioned device 101 verifies the public key or certificate (as provided by the key provisioning tool 103) against trusted root certificate or public key list. The trusted root certificate or public key list can be present on the un-provisioned device 101 with the firmware. In step 307, if the un-provisioned device 101 finds the public key or certificate to be invalid, an error is thrown. In step 308, if the un-provisioned device 101 finds the public key or certificate to be valid, the un-provisioned device 101 wraps the DK using the public key or certificate. In step 309, the un-provisioned device 101 then returns the DK to the key provisioning tool 103.

In step 310, the key provisioning tool 103 writes the wrapped DK to a persistent store and in step 311, the key provisioning tool 103 indicates that the DK provisioning is complete to the un-provisioned device 101. In step 312, the un-provisioned device 101 writes the DK in persistent storage, on receiving the indication from the key provisioning tool 103 that the DK provisioning is complete.

In step 313, the key provisioning tool 103 establishes a secure connection with the provisioning server 104, where both the key provisioning tool 103 and the provisioning server 104 are mutually authenticated (using any suitable means such as digital certificates and/or a one-time password in addition to user name & password). In step 314, on the mutual authentication being successfully completed, the key provisioning tool 103 provides details about the un-provisioned device 101 (device unique id, device mac, wrapped DK, serial number and other info about device such as device capabilities) to the provisioning server 104 and in step 315, the key provisioning tool 103 deletes the details after successful upload of device details to the provisioning server 104. In an embodiment herein, the key provisioning tool 103 may provide the details in batch mode, where details of set of devices are uploaded to the provisioning server 104 in bulk.

In step 316, the provisioning server 104 decrypts the DK, using the private key corresponding to public key/certificate used for wrapping the DK. In an embodiment herein, the provisioning server 104 can decrypt the DK, on receiving the wrapped DK and the details from the key provisioning tool 103. In an embodiment herein, the provisioning server 104 can decrypt the DK, only when needed; i.e., when provisioning is attempted on the un-provisioned device 101. In step 317, the provisioning server 104 stores information, such as information about the un-provisioned device 101, the DK, and so on.

In an embodiment herein, if there is a failure in connectivity between the un-provisioned device 101 and the key provisioning tool 103 during the provisioning process, the un-provisioned device 101 and the key provisioning tool 103 can reinitiate the provisioning process. In an embodiment, the un-provisioned device 101 and the key provisioning tool 103 can reinitiate the provisioning process from the point that the connectivity failed. In an embodiment, the un-provisioned device 101 and the key provisioning tool 103 can initiate the provisioning process from the start of the provisioning process. In an embodiment herein, the un-provisioned device 101 and the key provisioning tool 103 can inform the user of the initiation using a suitable interface such as the display (by displaying a pre-defined phrase), microphone (by vocalizing a pre-defined and pre-recorded phrase) or any other equivalent means.

The various actions in method 300 may be performed in the order presented, in a different order or simultaneously. Further, in some embodiments, some actions listed in FIGS. 3a and 3b may be omitted.

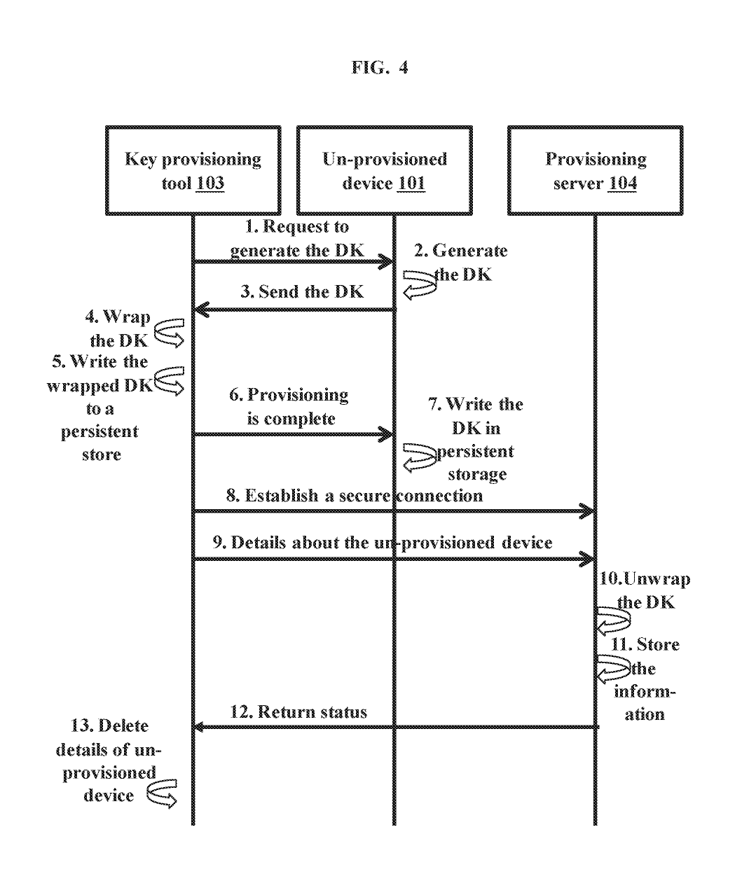

FIG. 4 is a sequence diagram showing the process of provisioning the DK. In step 1, the key provisioning tool 103 sends the request to generate the DK to the un-provisioned device 101. The request can also comprise of the public key or certificate that has to be used to wrap the DK. In step 2, the un-provisioned device 101 generates the DK, on receiving the request from the key provisioning tool 103. In step 3, the un-provisioned device 101 sends the DK in plain format to the key provisioning tool 103 (assuming that the un-provisioned device 101 is not capable of performing wrapping operation). In step 4, on receiving the DK in plain format, the key provisioning tool 103 wraps the DK using public key/certificate (on performing necessary validation of the public key or certificate).

In step 5, the key provisioning tool 103 writes the wrapped DK to a persistent store and in step 6, the key provisioning tool 103 indicates that the DK provisioning is complete to the un-provisioned device 101 by sending a communication. In step 7, the un-provisioned device 101 writes the DK in persistent storage, on receiving the indication from the key provisioning tool 103 that the DK provisioning is complete.

In step 8, the key provisioning tool 103 establishes a secure connection with the provisioning server 104, where both the key provisioning tool 103 and the provisioning server 104 are mutually authenticated (using any suitable means such as digital certificates and/or a one-time password in addition to user name & password). In step 9, on the mutual authentication being successfully completed, the key provisioning tool 103 provides details (device unique id, device mac, wrapped DK, serial number and other info about device such as device capabilities) about the un-provisioned device 101 to the provisioning server 104. In an embodiment herein, the key provisioning tool 103 may provide the details in batch mode, where details of set of devices are uploaded to the provisioning server 104 in bulk. In step 10, the provisioning server 104 unwraps the DK, using the private key corresponding to public key/certificate used for wrapping the DK. In an embodiment herein, the provisioning server 104 can unwrap the DK, on receiving the DK and the details from the key provisioning tool 103. In an embodiment herein, the provisioning server 104 can unwrap the DK, only when needed; i.e., when provisioning is attempted on the un-provisioned device 101. In step 11, the provisioning server 104 stores the information comprising of the un-provisioned device 101, the DK, and so on. In step 12, the provisioning server 104 returns the current status to the key provisioning tool 103. In step 13, on receiving the status message from the provisioning server 104, the key provisioning tool 103 deletes the details of the un-provisioned device (step 13).

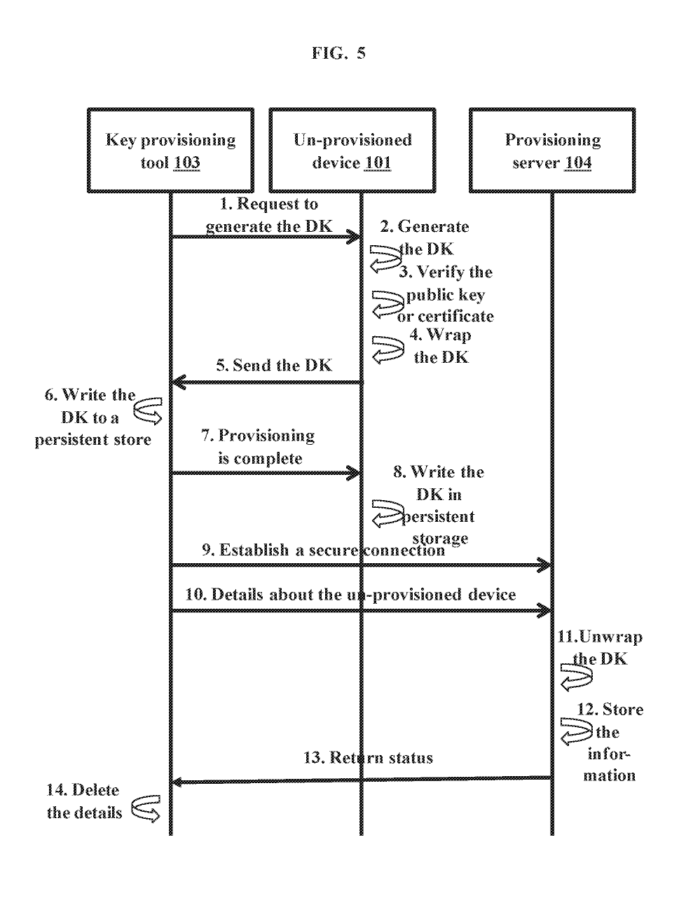

FIG. 5 is a sequence diagram showing the process of provisioning the DK. In step 1, the key provisioning tool 103 sends the request to generate the DK to the un-provisioned device 101. The request can also comprise of the public key or certificate that has to be used to wrap the DK. In step 2, the un-provisioned device 101 generates the DK, on receiving the request from the key provisioning tool 103. In step 3, the un-provisioned device 101 verifies the public key or certificate (as provided by the key provisioning tool 103) against trusted root certificate or public key list. In step 4, the un-provisioned device 101 wraps the DK using the public key or certificate. In step 5, the un-provisioned device 101 then returns the DK to the key provisioning tool 103.

In step 6, the key provisioning tool 103 writes the wrapped DK to a persistent store and in step 7, the key provisioning tool 103 indicates that the DK provisioning is complete to the un-provisioned device 101 by sending a communication. In step 8, the un-provisioned device 101 writes the DK in persistent storage, on receiving the indication from the key provisioning tool 103 that the DK provisioning is complete.

In step 9, the key provisioning tool 103 establishes a secure connection with the provisioning server 104, where both the key provisioning tool 103 and the provisioning server 104 are mutually authenticated (using any suitable means such as digital certificates and/or a one-time password in addition to user name & password). In step 10, on the mutual authentication being successfully completed, the key provisioning tool 103 provides details about the un-provisioned device 101 to the provisioning server 104. In step 11, the provisioning server 104 unwraps the DK, using the private key corresponding to public key/certificate used for wrapping the DK. In an embodiment herein, the provisioning server 104 can unwrap the DK, on receiving the DK and the details from the key provisioning tool 103. In an embodiment herein, the provisioning server 104 can unwrap the DK, only when needed; i.e., when provisioning is attempted on the un-provisioned device 101. In step 12, the provisioning server 104 stores the information comprising of the un-provisioned device 101, the DK, and so on. In step 13, the provisioning server 104 returns the current status to the key provisioning tool 103. On receiving the status message from the provisioning server 104, the key provisioning tool 103 deletes the details of the un-provisioned device (step 14).

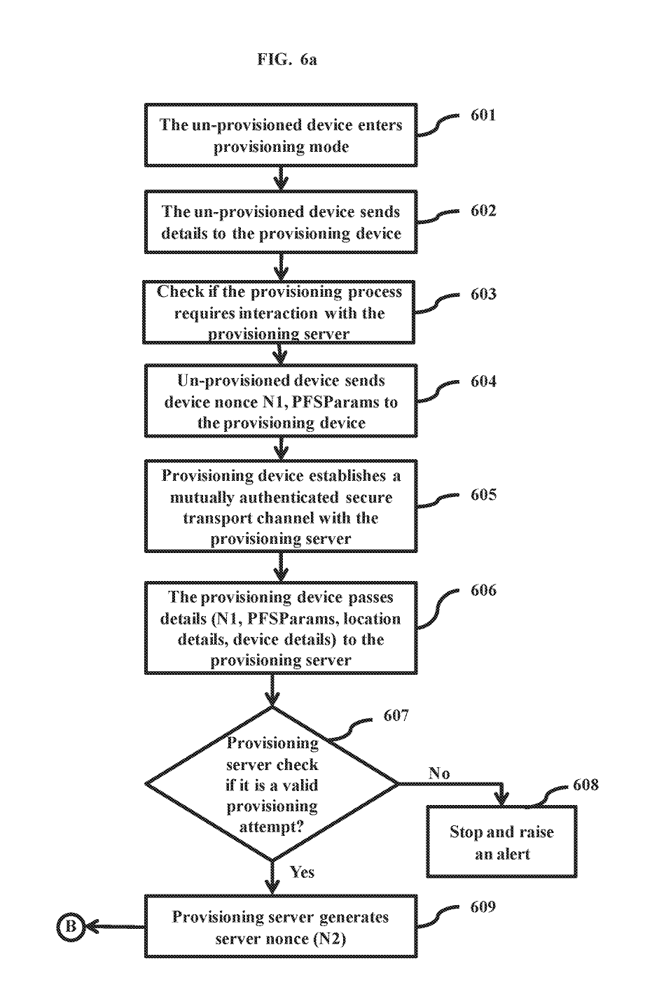

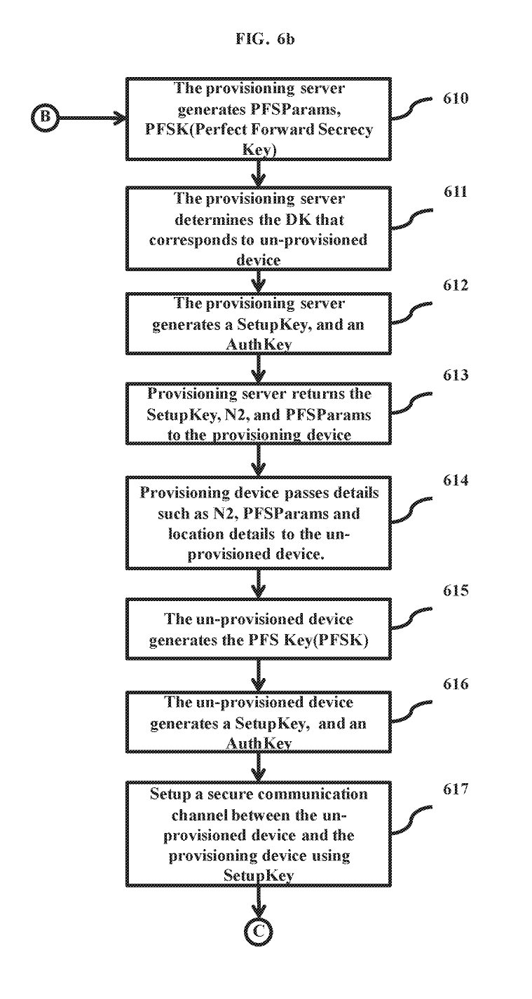

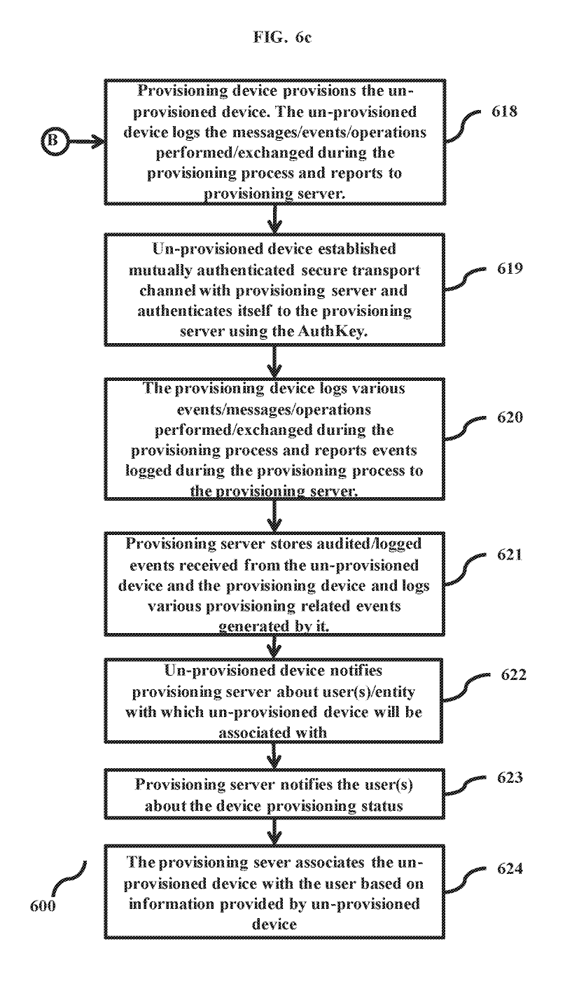

FIGS. 6a, 6b, and 6c are flowcharts depicting the process of provisioning the un-provisioned device. In step 601, the un-provisioned device 101 enters provisioning mode. The un-provisioned device 101 can enter the provisioning mode automatically. The un-provisioned device 101 can enter the provisioning mode, on receiving a pre-defined input from the user. The pre-defined input can be at least one of pressing at least one key/button/switch, providing at least one voice input (which can be a pre-assigned phrase), or any other equivalent means. On entering the provisioning mode, in an embodiment herein, the un-provisioned device 101 can provide an indication to the user that it has entered the provisioning mode. In an example, the un-provisioned device 101 can blink LED/lights of certain colours or in a certain sequence (say, as green LED blinks every 2 seconds). In another example, the provisioning device 102 can detect broadcast packets sent by the un-provisioned device 101 and provide a notification to the user.

In step 602, on the un-provisioned device 101 entering provisioning mode, the un-provisioned device 101 sends details to the provisioning device 102. The details can comprise of information about the un-provisioned device 101 that can be recognized by the provisioning device 102. The un-provisioned device 101 can send (which can be a unicast or a broadcast) non-confidential information about the un-provisioned device 101 to the provisioning device 102 such as MAC identifier prefixed/suffixed with a unique string that can be recognized by the provisioning device 102. If the un-provisioned device 101 supports multiple provisioning modes/methods, the un-provisioned device 101 can share the supported provisioning modes/methods with the provisioning device 102.

In step 603, the provisioning device 102 checks if the provisioning process requires interaction with the provisioning server 104.

In step 604, the un-provisioned device 101 sends a device nonce (N1), and PFS (Perfect Forward Secrecy) parameters (PFSParams) to the provisioning device 102. The device nonce (N1) is a non-repeating random number of arbitrary size. The un-provisioned device 101 can use a suitable algorithm such as DH (Diffie-Hellman) or RSA algorithm or Elliptic Curve Diffie-Hellman or any other suitable algorithm for PFS. Consider an example where the DH algorithm is used for generating the PFS, the un-provisioned device 101 and the provisioning server 104 generates one ephemeral DH key pair each (that lives for duration of the provisioning process), and the un-provisioned device 101 and the provisioning server 104 exchange a public DH key with each other to generate the PFS key (PFSK). Consider an example where the RSA algorithm is used for generating and exchanging the PFS key, the provisioning server 104 generates an ephemeral RSA key pair and passes the RSA public key to the un-provisioned device 101.The un-provisioned device 101 then generates a random value (call PFS key/PFSK), encrypts or wraps the PFS key (PFSK) using RSA public key received from the provisioning server 104 and transmits the encrypted/wrapped PFS key to the provisioning server 104. The provisioning server 104 uses corresponding RSA private key to decrypt/unwrap the encrypted/wrapped PFS key to get the plain PFS key. The sequence of message flows between the provisioning server 104 and the un-provisioned device 101 can vary depending on the algorithm for PFS.

In step 605, the provisioning device 102 establishes a mutually authenticated secure transport channel with the provisioning server 104. In an embodiment herein, the provisioning server 104 authenticates the provisioning device or user 102 using at least one suitable means such as a username/password, an optional one-time password (sent out of band to the provisioning device 102) or a digital certificate (provisioned on the provisioning device 102 out of band).

In step 606, the provisioning device 102 passes details comprising of the device nonce (N1), PFS parameters, location details, and so on to the provisioning server 104. Location details can comprise of latitude, longitude details. User can configure geofence details for his/her account that indicates from where the provisioning has to/cannot happen. The geofence can be boundary of a home, office or location where the un-provisioned device 101 is deployed/expected to be deployed. In an embodiment herein, the user can configure location details in the provisioning server 104 prior to starting provisioning.

In step 607, the provisioning server 104 checks if this provisioning attempt is a valid provisioning attempt. The provisioning server 104 first checks if the user has performed strong authentication (using at least one of a username/password, OTP, and the digital certificate) successfully, wherein the authentication can comprise of one or more rounds of authentication. The provisioning server 104 can further check if the user has a good reputation by checking if the user has any past incident of malicious activity such as attempt to provision device that he/she does not own. If reputation of the user is not good, the provisioning server 104 can stop the provisioning process and raise an alert. The provisioning server 104 can further compare location details against geofencing details provided by the provisioning device 102. The provisioning server 104 can also check if location details are close to location details historically used. If the provisioning server 104 is unable to verify the location details, the provisioning server 104 can stop the provisioning process and raise an alert (step 608).

In step 609, the provisioning server 104 generates a server nonce (N2). N2 can be a non-repeating random number of arbitrary size.

In step 610, the provisioning server 104 generates PFS parameters, a PFSK (Perfect Forward Secrecy (PFS) Key) by performing relevant activities on the provisioning server 104. The method used by the provisioning server 104 to generate the PFSK can depend on the public key algorithm chosen for PFS. If DH algorithm is used for generating the PFS, the provisioning server 104 generates a DH key pair. The provisioning server 104 then makes use of the DH public key received (PFS params) from the un-provisioned device 101 and the DH private key generated by the provisioning server 104 to generate the PFS key (PFSK). The DH public key generated by the provisioning server 104 can be passed as a PFS parameter to the un-provisioned device 101.

In step 611, the provisioning server 104 determines the Device Key (DK) that corresponds to the un-provisioned device 101. If the DK is encrypted/wrapped, the provisioning server 104 unwraps/decrypts the encrypted/wrapped DK to determine the DK in plain format.

In step 612, the provisioning server 104 generates a SetupKey and an AuthKey. The provisioning server 104 generates the SetupKey by applying a Password Based Key Derivation Function (PBKDF1 or PBKDF2 as explained in RFC (Request for Comments) 2898) using N1, N2, PFSK, location details, and DK as inputs. PBKDF1/PBKDF2 relies on PRF (Pseudo Random Function), which in turn relies on HMAC (Keyed-Hash Message Authentication Code) algorithm. Digest algorithm used by HMAC to generate SetupKey may either be fixed (such as SHA 256) or negotiated between the un-provisioned device 101 and the provisioning server 104. PBKDF1/PBKDF2 relies on input parameters password, salt, iteration count and length of key derived. To generate the SetupKey, the Device key (DK), which is a symmetric key, is used as a password, contacted N1, N2, PFSK, location details are used as salt. Iteration count is either fixed to a specific number (say 10000) or negotiated between the un-provisioned device 101 and the provisioning server 104. The length of the SetupKey derived can be either fixed (to a pre-defined number of units such as 32 bytes) or negotiated between the un-provisioned device 101 and the provisioning server 104. The provisioning server 104 generates the AuthKey by applying a Password Based Key Derivation Function (PBKDF1 or PBKDF2 as explained in RFC (Request for Comments) 2898) using N1, N2, location details, a prefixed string (say “authentication key”), and DK as inputs. PBKDF1/PBKDF2 relies on PRF (Pseudo Random Function), which in turn relies on HMAC (Keyed-Hash Message Authentication Code) algorithm. Digest algorithm used by HMAC to generate the AuthKey may either be fixed (such as SHA 256) or negotiated between the un-provisioned device 101 and the provisioning server 104. PBKDF1/PBKDF2 relies on input parameters password, salt, iteration count and length of key derived. To generate the AuthKey, Device Key (which is a symmetric key) is used as a password, contacted N1, N2 location details, and the prefixed string (say “authentication key”) is used as salt. Iteration count to generate the AuthKey is either fixed to a specific number (say 10000) or negotiated between the un-provisioned device 101 and the provisioning server 104. The length of the AuthKey derived can be either fixed (to a pre-defined number of units such as 32 bytes) or negotiated between the un-provisioned device 101 and the provisioning server 104.

If Device Key is asymmetric key (such as RSA/equivalent), provisioning server 104 can generate symmetric device key (which is random number of arbitrary size), wrap/encrypt using public key of un-provisioned device 101 and send to un-provisioned device 101. Un-provisioned device 101 unwraps/decrypts wrapped/encrypted symmetric device key using corresponding private key held in un-provisioned device 101. Symmetric device key is used as Device Key(DK) to perform provisioning operations explained in this method to generate the SetupKey, the AuthKey and other provisioning related operations. Similarly, if DH/equivalent asymmetric key is used, provisioning server 104 and un-provisioned device 101 participate to generate symmetric device key and use symmetric device key as Device Key(DK) to perform provisioning operations explained in this method to generate the SetupKey, the AuthKey and other provisioning related operations.

In step 613, the provisioning server 104 returns the SetupKey, server nonce (N2), and server PFSParams (such as DH public key of the provisioning server 104) to the provisioning device 102. In step 614, the provisioning device 102 passes details received from provision server 104 except the SetupKey such as N2, PFSParams and location details to the un-provisioned device 101.

In step 615, the un-provisioned device 101 uses PFSParams provided by the provisioning server 104 to generate the PFS key (PFSK). If DH is used for generating the PFS, the un-provisioned device 101 generates the PFSK using the DH public key received from the provisioning server 104 and the DH private key generated on the un-provisioned device 101.

In step 616, the un-provisioned device 101 generates the SetupKey and the AuthKey. The un-provisioned device 101 can generate the SetupKey by applying Password Based Key Derivation Function (PBKDF1 or PBKDF2 as explained in RFC 2898) passing N1, N2, PFSK, location details, DK as inputs. The un-provisioned device 101 will perform the same steps performed by the provisioning server 104 to derive the SetupKey and the AuthKey (as depicted in step 612). PBKDF1/PBKDF2 relies on PRF (Pseudo Random Function), which in turn relies on HMAC algorithm. Digest algorithm used by HMAC to generate the SetupKey may either be fixed (such as SHA 256) or may be negotiated between the un-provisioned device 101 and the provisioning server 104. PBKDF1/PBKDF2 relies on input parameters password, salt, iteration count and length of key derived. Device key is used as password, contacted N1, N2, PFSK, location details is used as salt, iteration count is either fixed to a specific number (say 10000) or negotiated between the un-provisioned device 101 and the provisioning server 104, length of key derived is either fixed (to say 32 bytes) or negotiated between the un-provisioned device 101 and the provisioning server 104. The un-provisioned device 101 can generate the AuthKey by applying Password Based Key Derivation Function (PBKDF1 or PBKDF2 as explained in RFC 2898) passing N1, N2, location details, a pre-fixed string (say “authentication key”), DK as inputs. The un-provisioned device 101 will perform the same steps performed by the provisioning server 104 to derive the AuthKey (as depicted in step 612). PBKDF1/PBKDF2 relies on PRF (Pseudo Random Function), which in turn relies on HMAC algorithm. Digest algorithm used by HMAC to generate the AuthKey may either be fixed (such as SHA 256) or may be negotiated between the un-provisioned device 101 and the provisioning server 104. PBKDF1/PBKDF2 relies on input parameters password, salt, iteration count and length of key derived. Device key(DK) is used as password, contacted N1, N2, location details, a pre-fixed string (say “authentication key”) is used as salt. Iteration count to generate the AuthKey is either fixed to a specific number (say 10000) or negotiated between the un-provisioned device 101 and the provisioning server 104, length of the AuthKey derived is either fixed (to say 32 bytes) or negotiated between the un-provisioned device 101 and the provisioning server 104.

In step 617, a secure communication channel between the un-provisioned device 101 and the provisioning device 102 is setup using the SetupKey. For example, if the un-provisioned device 101 and the provisioning device 102 make use of Wi-Fi, SetupKey (which can be base64 encoded) may be used as Wi-Fi WPA password to secure communication between them.

In step 618, the provisioning device 102 provisions the un-provisioned device 101. In an embodiment, the provisioning device 102 can fetch parameters related to the provisioning from a pre-defined location, such as the provisioning server 104, another server, the Cloud, a memory, or any other location. In an embodiment herein, the un-provisioned device 101 and the provisioning device 102 can use the SetupKey to encrypt sensitive information (such as home Wi-Fi password, keys, credentials, confidential provisioning information exchanged between the provisioning device 102 and the un-provisioned device 101). The provisioning device 102 provisions keys/secrets such as home Wi-Fi password, credentials that can used by un-provisioned device 101 for authentication, configuration settings, policies, information about users who can access the un-provisioned device 101, language settings, customized language pack(s) on the un-provisioned device 101. The un-provisioned device 101 logs the messages/events/operations performed/exchanged during the provisioning process. Un-provisioned device 101 establishes mutually authenticated secure transport channel with provisioning server 104, to report messages logged by it during provisioning process to the provisioning server 104.

In step 619, the un-provisioned device 101 establishes a mutually authenticated secure transport channel with provisioning server 104. Un-provisioned device 101 can communicate with provisioning server 104 directly or through provisioning device 102 where in provisioning device 102 acts as proxy. For example, if provisioning device 101 has Bluetooth connectivity only it won't be able to communicate with provisioning server 104 in internet using Bluetooth. In such scenarios, provisioning device 101 communicates with provisioning server 104 through provisioning device 102. Provisioning device 102 gets data from un-provisioned device 101 over Bluetooth, forwards to provisioning server 104 located in internet and vice versa.

The un-provisioned device 101 makes use of the AuthKey generated to authenticate itself with the provisioning server 104. For example, if HTTPS (Secure Hyper Text Transfer Protocol) is used for secure transport, the un-provisioned device 101 can make use of the AuthKey to perform HTTP basic or digest authentication (as explained in RFC 2617). If TLS (Transport Layer Security) is used between the un-provisioned device 101 and the provisioning server 104, the AuthKey can be used as PSK (Pre Shared Key) between the un-provisioned device 101 and the provisioning server 104 to perform PSK based TLS handshake to establish a secure transport channel.

In step 620, the provisioning device 102 logs various events/messages/operations performed/exchanged during the provisioning process and reports events logged during the provisioning process to the provisioning server 104. In step 621, the provisioning server 104 stores audited/logged events/messages/operations received from the un-provisioned device 101 and the provisioning device 102. The provisioning server 104 logs various events generated by it associated with the provisioning process. The provisioning server 104 makes use of provisioning related event logs generated by the un-provisioned device 101, the provisioning server 104, and the provisioning device 102. In an embodiment herein, the provisioning server 104 may employ automated/manual checks to verify if events collected from various sources are valid (i.e., reflects normal provisioning sequence). If log analysis reveals any suspicious activity, the provisioning server 104 can revoke the provisioning for the specific un-provisioned device 101. In step 622, un-provisioned device 101 notifies the provisioning server 104 about the user(s)/entity with which un-provisioned device need to be associated with. The un-provisioned device 101 can get information about user/entity from the provisioning device 102 during provisioning process. The un-provisioned device 101 may be associated with multiple users. If the provisioning process is successful, the un-provisioned device 101 stores the AuthKey in secure persistent storage for future use. If provisioning process fails, the AuthKey that was generated out of a previous successful provisioning, if any, will be retained. In step 623, the provisioning server 104 notifies the new user(s) about the provisioning status (by sending SMS, email, or any other suitable mechanism). If un-provisioned device 101 is associated with a user(s) already (referred as existing user), provisioning server 104 notifies existing user(s). In step 624, the provisioning server 104 associates the un-provisioned device 101 with the new user(s).

In an embodiment herein, the SetupKey can be generated using Device Key (DK) and a subset of parameters. For example, nonce values (N1, N2) generated by the un-provisioned device 101 and the provisioning server 104 in combination with the DK may be fed to the Key Derivation Function (PBKDF) to generate the SetupKey. Similarly, DK and PFS key (PFSK) may be fed to the PBKDF function to generate the SetupKey. Similarly, the AuthKey can be generated using subset of parameters. For example, N1,N2, a pre-defined string (say “authentication key”) can be used to generate the AuthKey.

In an embodiment, the PFSK can be generated between the un-provisioned device 101 and the provisioning device 102. The provisioning server 104 and the un-provisioned device 101 follows the above method to generate the SetupKey excluding PFS key. The Final SetupKey (FSK) is generated by the provisioning device 102 and the un-provisioned device 101 by combining the PFSK (generated between the provisioning device 102 and the un-provisioned device 101) and the SetupKey (generated by the un-provisioned device 101 or passed by the provisioning server 104 to the provisioning device 102). The final SetupKey (FSK) is used to secure communication between the un-provisioned device 101 and the provisioning device 102. This approach ensures that even the provisioning server 104 is not aware of the SetupKey.

In an embodiment herein, if there is a failure in connectivity between at least one of the un-provisioned device 101, the provisioning device 102, and the provisioning server 104 during the provisioning process, the un-provisioned device 101, the provisioning device 102 or the provisioning server 104 can reinitiate the provisioning process. In an embodiment, the provisioning process can be re-initiated from the point that the connectivity failed. In an embodiment, the provisioning process can be restarted. In an embodiment herein, the un-provisioned device 101 can inform the user of the restart using a suitable interface such as the display (by displaying a pre-defined phrase), microphone (by vocalizing a pre-defined and pre-recorded phrase), at least one display/light sequence or any other equivalent means.

In an embodiment hear-in, if Device Key is asymmetric key (such as RSA/equivalent), provisioning server 104 can generate symmetric device key (which is random number of arbitrary size), wrap/encrypt using public key of un-provisioned device 101 and send to un-provisioned device 101. Un-provisioned device 101 unwraps/decrypts wrapped/encrypted symmetric device key using corresponding private key held in un-provisioned device 101. Symmetric device key is used as Device Key(DK) to perform provisioning operations explained in above method to generate the SetupKey, the AuthKey and other provisioning related operations. Similarly, if DH/equivalent asymmetric key is used, provisioning server 104 and un-provisioned device 101 participate to generate symmetric device key and use symmetric device key as Device Key to perform provisioning operations explained in above method to generate the SetupKey, the AuthKey and other provisioning related operations.

In an embodiment herein, the un-provisioned device 101 can comprise of at least one user account. In an embodiment herein, the un-provisioned device 101 can require provisioning process to be performed separately for each account. In an embodiment herein, the un-provisioned device 101 can have a common provisioning process for all the accounts.

The various actions in method 600 may be performed in the order presented, in a different order or simultaneously. Further, in some embodiments, some actions listed in FIGS. 6a, 6b, and 6c may be omitted.

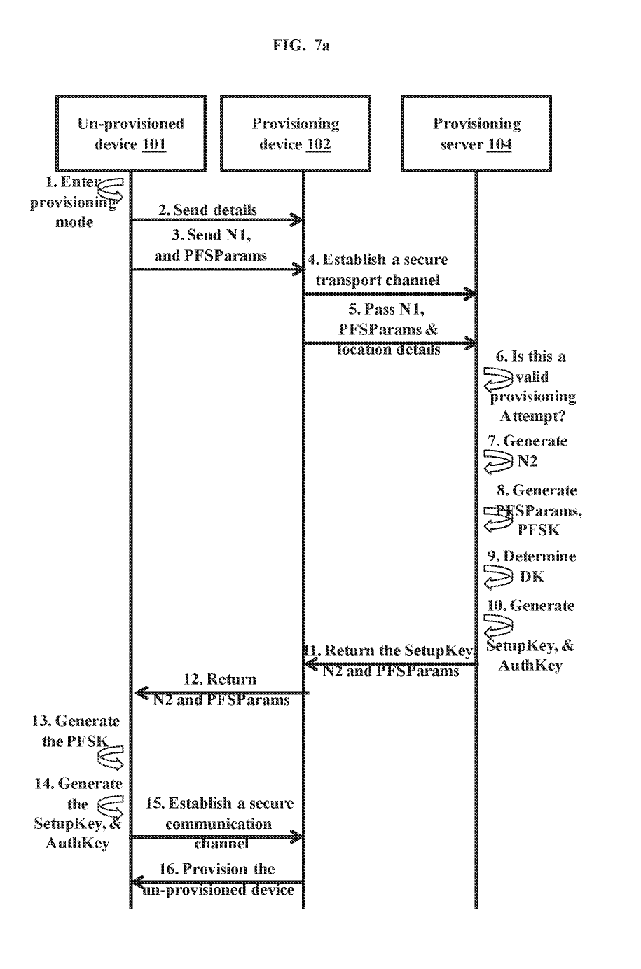

FIGS. 7a and 7b are sequence diagrams depicting the process of provisioning the un-provisioned device. In step 1, the un-provisioned device 101 enters the provisioning mode. The un-provisioned device 101 can enter the provisioning mode automatically. The un-provisioned device 101 can enter the provisioning mode, on receiving the pre-defined input from the user. On entering the provisioning mode, in an embodiment herein, the un-provisioned device 101 can provide an indication to the user that it has entered the provisioning mode. In step 2, the un-provisioned device 101 sends details to the provisioning device 102, on the un-provisioned device 101 entering provisioning mode. The details can comprise of information about the un-provisioned device 101 that can be recognized by the provisioning device 102. The un-provisioned device 101 can send (which can be a unicast or a broadcast) non-confidential information about the un-provisioned device 101 to the provisioning device 102. If the un-provisioned device 101 supports multiple provisioning modes/methods, the un-provisioned device 101 can share the supported provisioning modes/methods with the provisioning device 102. In step 3, the un-provisioned device 101 sends a device nonce (N1), and PFS (Perfect Forward Secrecy) parameters (PFSParams) to the provisioning device 102. The device nonce (N1) is a non-repeating random number of arbitrary size. The un-provisioned device 101 can use a suitable algorithm such as DH (Diffie-Hellman), Elliptic Curve Diffie-Hellman algorithm or RSA algorithm or any other suitable algorithm for PFS. In step 4, the provisioning device 102 establishes a mutually authenticated secure transport channel with the provisioning server 104. In step 5, the provisioning device 102 passes details comprising of the device nonce (N1), PFS parameters, location details, un-provisioned device identifier (such as MAC id prefixed/suffixed with a pre-defined string) and so on to the provisioning server 104. In step 6, the provisioning server 104 checks if this provisioning attempt is a valid provisioning attempt by checking if the user has performed strong authentication, if the user has a good reputation and by comparing location details against geofencing details provided by the user. The provisioning server 104 can also check if location details are close to location details historically used. In step 7, the provisioning server 104 generates a server nonce (N2). In step 8, the provisioning server 104 generates the PFS parameters, PFSK (Perfect Forward Secrecy (PFS) Key) by performing relevant activities on the provisioning server 104. The method used by the provisioning server 104 to generate the PFSK can depend on the public key algorithm chosen for PFS. In step 9, the provisioning server 104 determines the Device Key (DK) that corresponds to the un-provisioned device 101. If the DK is encrypted/wrapped, the provisioning server 104 unwraps/decrypts the encrypted/wrapped DK to determine the DK in plain format. In step 10, the provisioning server 104 generates the SetupKey and the AuthKey. The provisioning server 104 can generate the SetupKey by applying a Password Based Key Derivation Function (PBKDF1 or PBKDF2 as explained in RFC (Request for Comments) 2898) using N1, N2, PFSK, location details, and DK as inputs. PBKDF1/PBKDF2 relies on PRF (Pseudo Random Function), which in turn relies on HMAC (Keyed-Hash Message Authentication Code) algorithm. The length of the SetupKey derived can be either fixed (to a pre-defined number of units such as 32 bytes) or negotiated between the un-provisioned device 101 and the provisioning server 104. The provisioning server 104 can generate the AuthKey by applying a Password Based Key Derivation Function (PBKDF1 or PBKDF2 as explained in RFC (Request for Comments) 2898) using N1, N2, location details, a prefixed string (say “authentication key”), and DK as inputs. In step 11, the provisioning server 104 returns the SetupKey, server nonce (N2), and server PFSParams to the provisioning device 102. In step 12, the provisioning device 102 passes details such as N2, server PFSParams and location details to the un-provisioned device 101. In step 13, the un-provisioned device 101 uses the server PFSParams sent by the provisioning server 104 to generate the PFS key (PFSK). In step 14, the un-provisioned device 101 generates the SetupKey by applying Password Based Key Derivation Function (PBKDF1 or PBKDF2 as explained in RFC 2898) passing N1, N2, PFSK, location details, DK as inputs. The un-provisioned device 101 will perform the same steps performed by the provisioning server 104 to derive the SetupKey (as depicted in step 10). Further, in step 14, the un-provisioned device 101 generates the AuthKey by applying Password Based Key Derivation Function (PBKDF1 or PBKDF2 as explained in RFC 2898) passing N1, N2, location details, a pre-fixed string (say “authentication key”), DK as inputs. The un-provisioned device 101 will perform the same steps performed by the provisioning server 104 to derive the AuthKey (as depicted in step 10). In step 15, a secure communication channel between the un-provisioned device 101 and the provisioning device 102 is setup using the SetupKey. In step 16, the provisioning device 102 provisions the un-provisioned device 101 using the secure communication channel The provisioning device 102 provisions keys/secrets such as home Wi-Fi password, credentials that can used by un-provisioned device 101 for authentication, configuration settings, policies, information about users who can access the un-provisioned device 101, language settings, customized language pack on the un-provisioned device 101. In step 17, the un-provisioned device 101 logs the provisioning status, wherein the status comprises of messages/events/operations performed/exchanged during the provisioning process. In step 18, the provisioning device 102 logs the provisioning status, wherein the status comprises of various events/messages/operations performed/exchanged during the provisioning process. In step 19, the provisioning server 104 logs the status associated with provisioning process, wherein the status comprises of various events/messages/operations performed/exchanged during the provisioning process. In step 20, the un-provisioned device 101 established a mutually authenticated secure transport channel with the provisioning server 104. The un-provisioned device 101 and the provisioning server 104 can make use of the AuthKey to establish a secure transport channel and/or to authenticate un-provisioned device 101. The un-provisioned device 101 can communicate directly with the provisioning server 104 or the un-provisioned device 101 can communicate with the provisioning server 104 through the provisioning device 102 where in the provisioning device 102 acts as proxy. In Step 21, the un-provisioned device 101 reports the status to the provisioning server 104 where the status comprises of messages, events, operations related to provisioning in un-provisioned device 101. Further, in Step 21, the un-provisioned device 101 shares details about user(s)/entity (such as identified by user-id, token associated with user) with which the un-provisioned device 101 need to be associated with. The un-provisioned device 101 can get user related information when the un-provisioned device 101 and the provisioning device 102 communicate with each other during provisioning process. In step 22, the provisioning device 102 establishes a mutually authenticated secure transport channel with the provisioning server 104. In Step 23, the provisioning device 102 reports the status to the provisioning server 104 where the status comprises of messages, events, operations related to provisioning in provisioning device 102. In step 24, the provisioning server 104 stores the status logs received from the un-provisioned device 101 and the provisioning device 102. In step 25, the provisioning device associates the un-provisioned device 101 with the users(s)/entity based on information provided by un-provisioned device 101 in step 21. In step 26, the provisioning server 104 notifies the new user(s) about the device provisioning status (by sending SMS, email, or any other suitable mechanism). If the un-provisioned device 101 is already associated with a user(s) (referred to as existing user(s)) before this provisioning process, the provisioning server 104 can notify the existing user(s) about the provisioning status. In step 27, the provisioning server 104 associates the AuthKey generated with un-provisioned device 101 for future interaction with un-provisioned device 101.

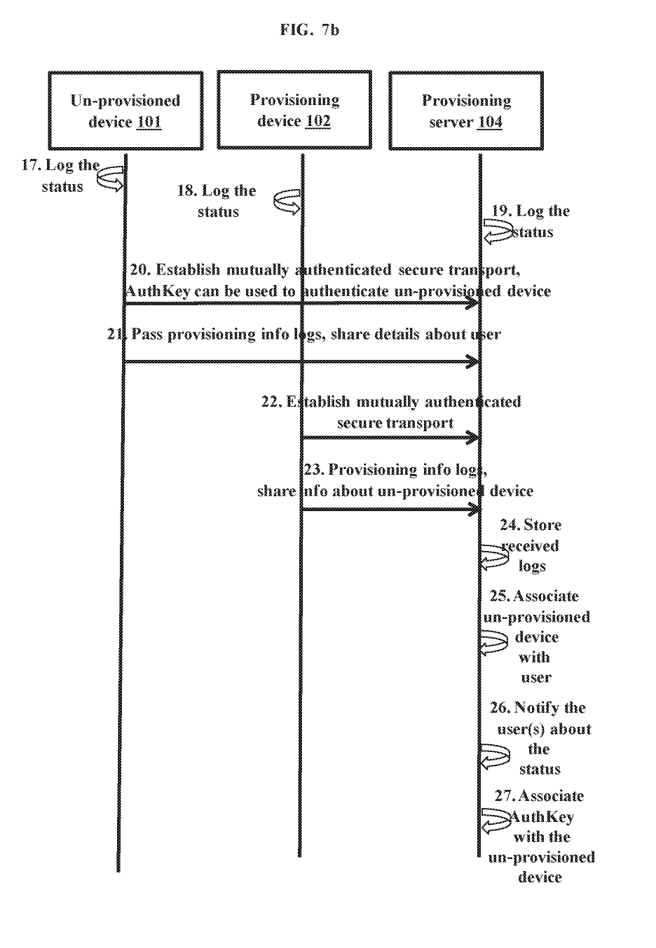

FIG. 8 depicts the key provisioning tool. The key provisioning tool 103, as depicted, comprises of a controller 801, at least one communication interface 802, and a memory 803. In an embodiment, the memory 803 can be present locally. In an embodiment, the memory 803 can be present remotely, and can be at least one of a server, a file server, a data server, the Cloud, and so on. The communication interface 802 can use at least one of wired and/or wireless means for communication with external entities such as the un-provisioned device 101, the provisioning server 104 (using a suitable means such as Wi-Fi, Bluetooth, and so on).

The controller 801 can send the request to generate the DK to the un-provisioned device 101, using the communication interface 802. The request can carry a public key or certificate that has to be used by un-provisioned device 101 to wrap the DK. The public key or the certificate used by the controller 801 can depend on the capability of the un-provisioned device 101. If the un-provisioned device 101 is not capable of performing wrapping operation, the un-provisioned device 101 sends the DK in plain format to the controller 801, using the communication interface 802. On receiving the DK in plain format, the controller 801 performs necessary validation of the public key or certificate. The trusted root certificate or public key list can be present in the memory 803. If the controller 801 is unable to perform successful validation, the controller 801 throws an error. On successfully performing the validation of public key or certificate, the controller 801 wraps the DK using public key/certificate. On receiving the wrapped Device Key (DK), the controller 801 writes the wrapped DK to the memory 803 and indicates that the DK provisioning is complete to the un-provisioned device 101.

The controller 801 then establishes a mutually authenticated secure transport channel with the provisioning server 104. The controller 801 provides details about the un-provisioned device 101 (device unique id, device mac, wrapped DK, serial number and other info about device such as device capabilities) to the provisioning server 104, using the communication interface 802. The controller 801 can delete the details from the memory 803, after successful upload of device details to the provisioning server 104. In an embodiment herein, the controller 801 may provide the details in batch mode, where details of set of devices are uploaded to the provisioning server 104 in bulk.

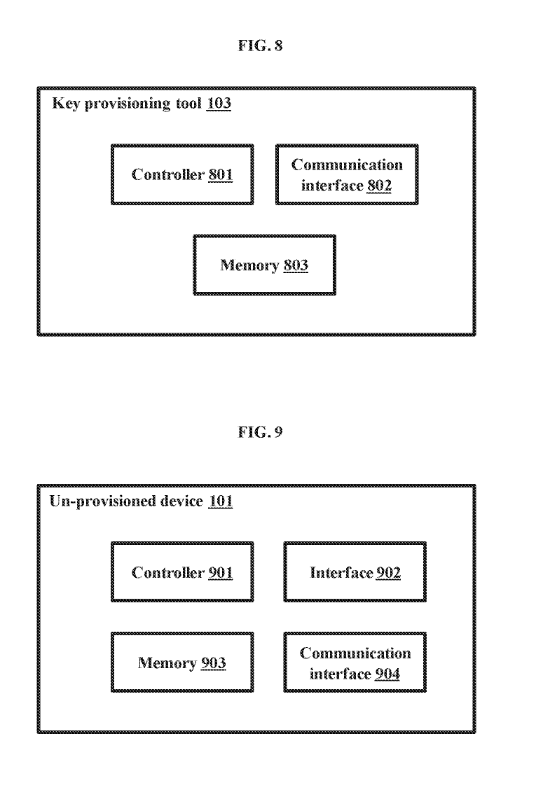

FIG. 9 depicts the un-provisioned device. The un-provisioned device 101, as depicted, comprises of a controller 901, at least one interface 902, a memory 903, and at least one communication interface 904. The interface 902 can be at least one of a display, a speaker, at least one switch/button/toggle, and so on. In an embodiment herein, the un-provisioned device need not comprise of a memory 903. In an embodiment, the memory 903 can be present locally. In an embodiment, the memory 903 can be present remotely, and can be at least one of a server, a file server, a data server, the Cloud, and so on. The communication interface 904 can use at least one of wired and/or wireless means for communication (such as Wi-Fi, Bluetooth, and so on).

On receiving a request to generate the DK from the key provisioning tool 103 (wherein the request can comprise of the public key or certificate that has to be used to wrap the DK), the controller 901 generates the DK. The DK may be at least one of a symmetric key (which can be a random value) or an asymmetric key. If the controller 901 is not capable of performing wrapping operation (which can be due to at least one of a hardware or a software limitation), the controller 901 sends the DK in plain format to the key provisioning tool 103 using the communication interface 904. If the controller 901 is capable of performing wrapping operation, the controller 901 verifies the public key or certificate (as provided by the key provisioning tool 103) against a trusted root certificates or public key list. The trusted root certificates or public key list can be present on the un-provisioned device 101 in the memory 903. If the un-provisioned device 101 finds the public key or certificate to be invalid, the controller 901 throws an error. If the controller 901 finds the public key or certificate to be valid, the controller 901 wraps the DK using the public key or certificate and then returns the wrapped DK to the key provisioning tool 103.

The controller 901 can enter provisioning mode. The un- controller 901 can enter the provisioning mode automatically, on at least one pre-defined condition being satisfied. The controller 901 can enter the provisioning mode, on receiving a pre-defined input from the user. The pre-defined input can be at least one of pressing at least one key/button/switch, providing at least one voice input (which can be a pre-assigned phrase), or any other equivalent means. On entering the provisioning mode, in an embodiment herein, the controller 901 can provide an indication to the user that it has entered the provisioning mode using the interface 902. On the un-provisioned device 101 entering provisioning mode, the controller 901 sends details to the provisioning device 102 using the communication interface 904. The details can comprise of information about the un-provisioned device 101 that can be recognized by the provisioning device 102. The un-provisioned device 101 can send (which can be a unicast or a broadcast) non-confidential information about the un-provisioned device 101 to the provisioning device 102 such as MAC identifier prefixed/suffixed with a unique string that can be recognized by the provisioning device 102. If the un-provisioned device 101 supports multiple provisioning modes/methods, the controller 901 can share the supported provisioning modes/methods with the provisioning device 102.In an embodiment herein, during provisioning process the controller 901 generates device nonce (N1), PFS parameters and sends them to provisioned device 102 through communication interface 904.

On receiving detail such as the server nonce (N2), and PFSParams from the provisioning server 104 through the provisioning device 102, the controller 901 uses the server PFSParams and PFS parameters that the controller 901 has to generate the PFSK. If DH is used for PFS, the controller 901 generates the PFSK using the DH public key received from the provisioning server 104 and the DH private key generated on the un-provisioned device 101. The controller 901 generates the SetupKey by applying Password Based Key Derivation Function (PBKDF1 or PBKDF2 as explained in RFC 2898) passing N1, N2, PFSK, location details, DK as inputs. The controller 901 will perform the same steps performed by the provisioning server 104 to derive the SetupKey. The controller 901 sets up a secure communication channel between the un-provisioned device 101 and the provisioning device 102 using the SetupKey. The controller 901 on the un-provisioned device 101 generates the AuthKey by applying Password Based Key Derivation Function (PBKDF1 or PBKDF2 as explained in RFC 2898) passing N1, N2, location details, a pre-fixed string (say “authentication key”), DK as inputs. The controller 901 enables the provisioning device 102 to provision the un-provisioned device 101. In an embodiment herein, the controller 901 can use the SetupKey to encrypt sensitive information (such as home Wi-Fi password, keys, confidential provisioning information exchanged between the provisioning server/provisioning device 102 and the un-provisioned device 101). The controller 901 can enable the provisioning device 102 to provision language settings, customized language pack as per user's choice on the un-provisioned device 101. The AuthKey generated by the controller 901 can be used by the un-provisioned device 101 to authenticate the un-provisioned device 101 with the provisioning server 104.

The controller 901 further logs the messages/events/operations performed/exchanged during the provisioning process. The controller 901 can report the messages logged during provisioning process to the provisioning server 104, either directly or through the provisioning device 102.

In an embodiment herein, the controller 901 can generate the SetupKey using the Device Key (DK) and a subset of other parameters. For example, nonce values(N1,N2) generated by the controller 901 and the provisioning server 104 in combination with the DK may be fed to the Key Derivation Function (PBKDF) to generate the SetupKey. Similarly, DK and PFS key (PFSK) may be fed to the PBKDF function to generate the SetupKey.

In an embodiment herein, the controller 901 can manage multiple user accounts. In an embodiment herein, the controller 901 can require provisioning process to be performed separately for each account. In an embodiment herein, the controller 901 can have a common provisioning process for all the accounts.

The un-provisioning device 101 can communicate with provisioning server 104 either directly or through provisioning device 102. Provisioning device 102 can act as proxy to enable un-provisioned device 101 and provisioning server 104 to communicate with each other.

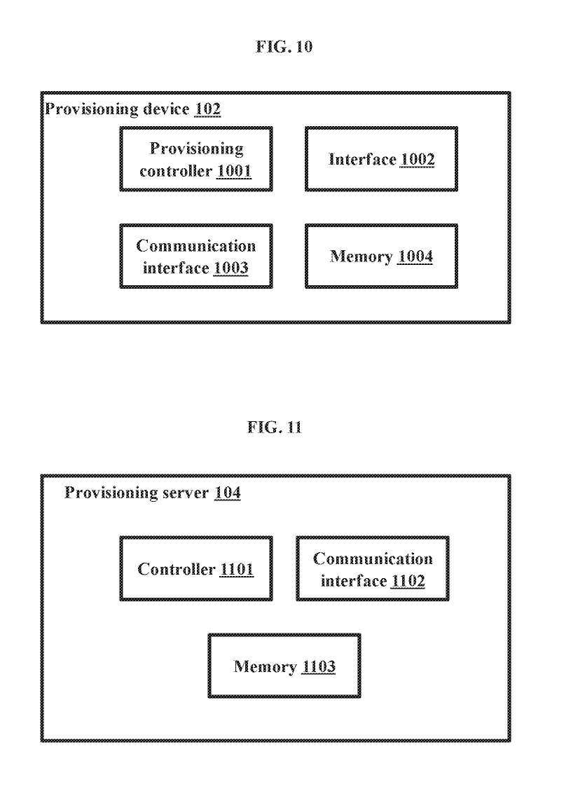

FIG. 10 depicts the provisioning device. The provisioning device 102, as depicted, comprises of a provisioning controller 1001, at least one interface 1002, at least one communication interface 1003, and a memory 1004. The interface 1002 can be at least one of a display, a speaker, a keyboard, and so on. The communication interface 1003 can use at least one of wired and/or wireless means for communication (such as Wi-Fi, Bluetooth, cellular, and so on). In an embodiment, the memory 1004 can be present locally. In an embodiment, the memory 1004 can be present remotely, and can be at least one of a server, a file server, a data server, the Cloud, and so on.

On the un-provisioned device 101 entering provisioning mode, the controller 1001 receives details sent by the provisioning device 102, using the communication interface 1003. The details can comprise of information about the un-provisioned device 101 that can be recognized by the controller 1001. In an embodiment herein, controller 1001 can check if the provisioning process requires interaction with the provisioning server 104. The controller 1001 forwards N1, PFSParams, un-provisioned device's identifier such as un-provisioned device 101 MAC id (received from the un-provisioned device 101), location details collected by provisioning device 102 to the provisioning server 104 over mutually authenticated secure transport channel.

The controller 1001 receives SetupKey, server nonce(N2) and server PFSParams from the provisioning server 104 and forwards the server nonce (N2), and server PFSParams as received from the provisioning server 104 to the un-provisioned device 101.

The controller 1001 assists in setting up a secure communication channel between the un-provisioned device 101 and the provisioning device 102 using the SetupKey. The controller 1001 further provisions the un-provisioned device 101, using the secure communication channel In an embodiment, the controller 1001 can fetch parameters related to the provisioning from a pre-defined location, such as the provisioning server 104, another server, the Cloud, a memory, or any other location. In an embodiment herein, the controller 1001 can use the SetupKey to encrypt sensitive information (such as home Wi-Fi password, keys, confidential provisioning information exchanged between the provisioning server/provisioning device 102 and the un-provisioned device 101). The controller 1001 provisions keys/secrets such as home Wi-Fi password, credentials that can used by un-provisioned device 101 for authentication, configuration settings, policies, information about users who can access the un-provisioned device 101, language settings, customized language pack on the un-provisioned device 101.

The controller 1001 also logs various events/messages/operations performed/exchanged during the provisioning process in the memory 1004 and reports events logged during the provisioning process to the provisioning server 104.

The provisioning device 102 enables un-provisioned device 101 to communicate with provisioning server 104 through provisioning device 102. Provisioning device 102 can act as proxy to enable un-provisioned device 101 and provisioning server 104 to communicate with each other.

FIG. 11 depicts the provisioning server. The provisioning server 104, as depicted, comprises of a controller 1101, a memory 1102, and at least one communication interface 1103. The communication interface 1103 can use at least one of wired and/or wireless means for communication (such as Wi-Fi, LAN, cellular, and so on). In an embodiment, the memory 1102 can be present locally. In an embodiment, the memory 1102 can be present remotely, and can be at least one of a server, a file server, a data server, the Cloud, and so on.

The controller 1101 establishes a secure transport channel with the provisioning device 102. In an embodiment herein, the controller 1101 authenticates the provisioning device 102 using at least one suitable means such as a username/password, an optional one-time password (sent out of band to the provisioning device 102) or a digital certificate (provisioned on the provisioning device 102 out of band).

The controller 1101 receives the details from the provisioning device 102, wherein the details comprise of the nonce (N1), PFSParams, un-provisioned device identifier such as MAC id prefixed/suffixed with pre-defined string, location details, and so on. The controller 1101 first checks if this provisioning attempt is a valid provisioning attempt by checking if the user has performed strong authentication, if the user has a good reputation, by comparing location details against geofencing details configured by user, and so on. If the provisioning server 104 is unable to validate the provisioning attempt, the provisioning server 104 can stop the provisioning process and raise an alert.

The controller 1101 generates the server nonce (N2), PFS params, the PFSK using PFS params received from un-provisioned device 101 and PFS related parameters generated by provisioning server 104, the DK that corresponds to the un-provisioned device 101, the SetupKey and the AuthKey. The controller 1101 returns the SetupKey, server nonce (N2), and the server PFSParams to the provisioning device 102.

The controller 1101 receives the statuses/logs from the un-provisioned device 101 and the provisioning device 102. The controller 1101 also logs various events associated with provisioning process. In an embodiment herein, the controller 1101 may employ automated/manual checks to verify if events collected from various sources are valid (i.e., reflects normal provisioning sequence). If log analysis reveals any suspicious activity, the controller 1101 can revoke the provisioning status of un-provisioned device. The controller 1101 associates un-provisioned device 101 with user(s)/entity based on information it received from un-provisioned device 101. The controller 1101 authenticates un-provisioned device 1101 based on the AuthKey generated during provisioning process. The controller 1101 notifies the new user(s) about the device provisioning status (by sending SMS, email, or any other suitable mechanism),In an embodiment herein, if the un-provisioned device 101 was already associated with other user(s)/entity (referred to as existing user(s)) before current provisioning process, the controller 1101 notifies the existing user(s) about device provisioning status (by sending SMS, email or any other suitable mechanism).

Embodiments herein can work on un-provisioned devices that have connectivity and are constrained in terms of hardware capabilities (such as processing power, storage, and so on). The un-provisioned device 101 need not have display, speaker, microphone, keyboard, and so on. Further, the un-provisioned device 101 need not have capability to perform public key operations or have capability to run secure transport using protocols like TLS (Transport Layer Security) or any other equivalent means.

Embodiments herein do not require the user to manage PIN (Personal Identification Number)/QR code printed on the packaging/device for the lifetime of the device.

According to embodiments as disclosed herein, the SetupKey and the AuthKey keep changing every time the device is provisioned. Even if the SetupKey is leaked (for example, post provisioning), it does not cause harm. A control is maintained on who is involved in provisioning and can stop wrong/suspicious users from performing the provisioning operation. This is secure and user friendly compared to PIN or QR code printed on the product package and/or the product.

The embodiment disclosed herein describes methods and systems for provisioning headless devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for provisioning an un-provisioned device, the method comprising
generating and sending a device nonce (N1) and PFSParams (Perfect Forward Secrecy (PFS) parameters) to a provisioning device by the un-provisioned device;
providing the N1, the PFSParams, location details and device details of the un-provisioned device to a provisioning server by the provisioning device using a mutually authenticated secure transport channel;
generating a server nonce (N2), server PFSParams and a PFSK (Perfect Forward Secrecy (PFS) Key) by the provisioning server;
determining a device key (DK) for the un-provisioned device by the provisioning server;
generating a SetupKey by the provisioning server using the N1, the N2, the location details, the PFSK and the DK;
sending the SetupKey to the provisioning device by the provisioning server;
sending the N2 and server PFSParams by the provisioning server to the un-provisioned device through the provisioning device;
generating a PFSK by the un-provisioned device using the server PFSParams;
generating the SetupKey by the un-provisioned device using the N1, the N2, the PFSK, the location details and the DK;
setting up a secure communication channel between the un-provisioned device and the provisioning device using the SetupKey; and
provisioning the un-provisioned device by the provisioning device over the secure communication channel.

2. The method, as claimed in claim 1, wherein the method comprises of provisioning the DK for the un-provisioned device, further comprising
generating the DK by the un-provisioned device, on receiving a request from a key provisioning tool;
sending the DK to the key provisioning tool by the un-provisioned device, wherein the DK can be at least one of in a plain format; and a wrapped DK;
wrapping the DK by the key provisioning tool, if the DK is not wrapped;
writing the wrapped DK to a store by the key provisioning tool;
indicating that the DK provisioning is complete to the un-provisioned device by the key provisioning tool;
writing the wrapped DK to a store by the un-provisioned device;
providing details about the un-provisioned device by the key provisioning tool to the provisioning server over a secure connection;
unwrapping the wrapped DK by the provisioning server; and
storing details about the un-provisioned device including DK by the provisioning server.

3. The method, as claimed in claim 1, wherein N1 is a non-repeating random number of arbitrary size.

4. The method, as claimed in claim 1, wherein the un-provisioned device generates the PFSParams using at least one of a Diffie-Hellman algorithm; Elliptic Curve Diffie-Hellman algorithm and a RSA algorithm.

5. The method, as claimed in claim 1, wherein the method further comprises of the provisioning server checking if the provisioning attempt is a valid provisioning attempt.

6. The method, as claimed in claim 1, wherein N2 is a non-repeating random number of arbitrary size.

7. The method, as claimed in claim 1, wherein the method further comprises of the provisioning server unwraps/decrypts the DK, if the DK is wrapped/encrypted.

8. The method, as claimed in claim 1, wherein generating the SetupKey by the provisioning server comprises of applying a Password based key derivation function, wherein the N1, the N2, the PFSK, the location details and the DK are inputs to the Password based key derivation function.

9. The method, as claimed in claim 1, wherein generating the SetupKey by the un-provisioned device comprises of applying a Password based key derivation function, wherein the N1, the N2, the PFSK, the location details and the DK are inputs to the Password based key derivation function.

10. The method, as claimed in claim 1, wherein the method further comprises of
logging messages/events/operations performed/exchanged during provisioning by the un-provisioned device;
reporting the logged messages/events/operations performed/exchanged during the provisioning to the provisioning server by the un-provisioned device; and
storing the reported information by the provisioning server.

11. The method, as claimed in claim 10, wherein the method further comprises of
checking for at least one discrepancy based on the stored information and the logged information; and
taking at least one action by the provisioning server, on finding at least one discrepancy.

12. The method, as claimed in claim 1, wherein the method further comprises of
logging messages/events/operations performed/exchanged during provisioning by the provisioning device;
reporting the logged messages/events/operations performed/exchanged during the provisioning to the provisioning server by the provisioning device; and
storing the reported information by the provisioning server.

13. The method, as claimed in claim 12, wherein the method further comprises of
checking for at least one discrepancy based on the stored information and the logged information; and
taking at least one action by the provisioning server, on finding at least one discrepancy.

14. The method, as claimed in claim 1, wherein the method further comprises of logging messages/events/operations performed/exchanged during provisioning by the provisioning server.

15. The method, as claimed in claims 14, wherein the method further comprises of
checking for at least one discrepancy based on the stored information and the logged information; and
taking at least one action by the provisioning server, on finding at least one discrepancy.

16. The method, as claimed in claim 1, wherein the method further comprises of
notifying at least one user about the provisioning status by the provisioning server; and
associating the un-provisioned device with at least one user by the provisioning server.

17. The method, as claimed in claim 1, wherein the method further comprises of
generating an AuthKey by the provisioning server;
generating the AuthKey by the un-provisioned device; and
performing authentication with the provisioning server by the un-provisioned device using the AuthKey.

18. The method, as claimed in claim 17, wherein the provisioning server generates the AuthKey by applying a Password Based Key Derivation Function using the N1, the N2, location details, prefixed string (such as “authentication key”) and the DK as inputs.

19. The method, as claimed in claim 17, wherein the un-provisioned device generates the AuthKey by applying a Password Based Key Derivation Function using the N1, the N2, location details, prefixed string (such as “authentication key”) and the DK as inputs.

20. The method, as claimed in claim 1, wherein the method further comprises of the un-provisioned device communicating directly with the provisioning server.

21. The method, as claimed in claim 1, wherein the method further comprises of the un-provisioned device communicating with the provisioning server through the provisioning device.

22. The method, as claimed in claim 1, wherein provisioning the un-provisioned device comprises of provisioning the un-provisioned device with at least one of Wi-Fi password, credentials that can used by the un-provisioned device for authentication, configuration settings, policies, information about users who can access the un-provisioned device, language settings, and at least one customized language pack.

23. A system for provisioning an un-provisioned device, the system comprising of a provisioning device, and a provisioning server, the system configured for
generating and sending a device nonce (Ni) and PFSParams (Perfect Forward Secrecy (PFS) parameters) to the provisioning device by the un-provisioned device;
providing the N1, the PFSParams, location details and device details of the un-provisioned device to the provisioning server by the provisioning device using a mutually authenticated secure transport channel;
generating a server nonce (N2), server PFSParams and a PFSK (Perfect Forward Secrecy (PFS) Key) by the provisioning server;
determining a device key (DK) for the un-provisioned device by the provisioning server;
generating a SetupKey by the provisioning server using the N1, the N2, the location details, the PFSK and the DK;
sending the SetupKey to the provisioning device by the provisioning server;
sending the N2 and server PFSParams by the provisioning server to the un-provisioned device through the provisioning device;
generating a PFSK by the un-provisioned device using the server PFSParams;
generating the SetupKey by the un-provisioned device using the N1, the N2, the PFSK, the location details and the DK;
setting up a secure communication channel between the un-provisioned device and the provisioning device using the SetupKey; and
provisioning the un-provisioned device by the provisioning device over the secure communication channel.

24. The system, as claimed in claim 23, wherein the system comprises of a key provisioning tool for provisioning the DK for the un-provisioned device, and the system is further configured for generating the DK by the un-provisioned device, on receiving a request from the key provisioning tool;
sending the DK to the key provisioning tool by the un-provisioned device, wherein the DK can be at least one of in a plain format; and a wrapped DK;
wrapping the DK by the key provisioning tool, if the DK is not wrapped;
writing the wrapped DK to a store by the key provisioning tool;
indicating that the DK provisioning is complete to the un-provisioned device by the key provisioning tool;
writing the wrapped DK to a store by the un-provisioned device;
providing details about the un-provisioned device by the key provisioning tool to the provisioning server over a secure connection;
unwrapping the wrapped DK by the provisioning server; and
storing details about the un-provisioned device including DK by the provisioning server.

25. The system, as claimed in claim 23, wherein N1 is a non-repeating random number of arbitrary size.

26. The system, as claimed in claim 23, wherein the un-provisioned device is configured to generate the PFSParams using at least one of a Diffie-Hellman algorithm; Elliptic Curve Diffie-Hellman algorithm and a RSA algorithm.

27. The system, as claimed in claim 23, wherein the provisioning server is further configured to check if the provisioning attempt is a valid provisioning attempt.

28. The system, as claimed in claim 23, wherein N2 is a non-repeating random number of arbitrary size.

29. The system, as claimed in claim 23, wherein the provisioning server is further configured to unwrap/decrypt the DK, if the DK is wrapped/encrypted.

30. The system, as claimed in claim 23, wherein the provisioning server is configured for generating the SetupKey by applying a Password based key derivation function, wherein the N1, the N2, the PFSK, the location details and the DK are inputs to the Password based key derivation function.

31. The system, as claimed in claim 23, wherein the un-provisioned device is configured for generating the SetupKey by applying a Password based key derivation function, wherein the N1, the N2, the PFSK, the location details and the DK are inputs to the Password based key derivation function.

32. The system, as claimed in claim 23, wherein the system is further configured for
logging messages/events/operations performed/exchanged during provisioning by the un-provisioned device;
reporting the logged messages/events/operations performed/exchanged during the provisioning to the provisioning server by the un-provisioned device; and
storing the reported information by the provisioning server.

33. The system, as claimed in claim 32, wherein the provisioning server is further configured for
checking for at least one discrepancy based on the stored information and the logged information; and
taking at least one action, on finding at least one discrepancy.

34. The system, as claimed in claim 23, wherein the system is further configured for
logging messages/events/operations performed/exchanged during provisioning by the provisioning device;
reporting the logged messages/events/operations performed/exchanged during the provisioning to the provisioning server by the provisioning device; and
storing the reported information by the provisioning server.

35. The system, as claimed in claim 34, wherein the provisioning server is further configured for
checking for at least one discrepancy based on the stored information and the logged information; and
taking at least one action, on finding at least one discrepancy.

36. The system, as claimed in claim 23, wherein the provisioning server is further configured for logging messages/events/operations performed/exchanged during provisioning.

37. The system, as claimed in claim 36, wherein the provisioning server is further configured for
checking for at least one discrepancy based on the stored information and the logged information; and
taking at least one action, on finding at least one discrepancy.

38. The system, as claimed in claim 23, wherein the provisioning server is further configured for
notifying at least one user about the provisioning status; and
associating the un-provisioned device with at least one user.

39. The system, as claimed in claim 23, wherein the system is further configured for
generating an AuthKey by the provisioning server;
generating the AuthKey by the un-provisioned device; and
performing authentication with the provisioning server by the un-provisioned device using the AuthKey.

40. The system, as claimed in claim 39, wherein the provisioning server is configured to generate the AuthKey by applying a Password Based Key Derivation Function using the N1, the N2, location details, prefixed string (such as “authentication key”) and the DK as inputs.

41. The system, as claimed in claim 39, wherein the un-provisioned device is configured to generate the AuthKey by applying a Password Based Key Derivation Function using the N1, the N2, location details, prefixed string (such as “authentication key”) and the DK as inputs.

42. The system, as claimed in claim 23, wherein the un-provisioned device is configured to communicate directly with the provisioning server.

43. The system, as claimed in claim 23, wherein the un-provisioned device is configured to communicate with the provisioning server through the provisioning device.

44. The system, as claimed in claim 23, wherein the provisioning device is configured for provisioning the un-provisioned device with at least one of Wi-Fi password, credentials that can used by the un-provisioned device for authentication, configuration settings, policies, information about users who can access the un-provisioned device, language settings, and at least one customized language pack.

45. A device configured for
generating and sending a device nonce (N1) and PFSParams (Perfect Forward Secrecy (PFS) parameters) to a provisioning device;
receiving a server nonce (N2) and a server PFSParams from the provisioning server through the provisioning device;
generating a PFSK (Perfect Forward Secrecy (PFS) Key) using the server PFSParams;
generating a SetupKey using the N1, the N2, the PFSK, location details of the device and a device key (DK);
setting up a secure communication channel between the device and the provisioning device using the SetupKey; and
being provisioned by the provisioning device over the secure communication channel.

46. The device, as claimed in claim 45, wherein device is further configured for
generating the DK, on receiving a request from a key provisioning tool;
sending the DK to the key provisioning tool, wherein the DK can be at least one of in a plain format; and a wrapped DK; and
writing the wrapped DK to a store, on receiving an indication from the key provisioning tool that provisioning is complete.

47. The device, as claimed in claim 45, wherein N1 is a non-repeating random number of arbitrary size.

48. The device, as claimed in claim 45, wherein the device is configured to generate the PFSParams using at least one of a Diffie-Hellman algorithm; Elliptic Curve Diffie-Hellman algorithm and a RSA algorithm.

49. The device, as claimed in claim 45, wherein the device is configured for generating the SetupKey by applying a Password based key derivation function, wherein the N1, the N2, the PFSK, the location details and the DK are inputs to the Password based key derivation function.

50. The device, as claimed in claim 45, wherein the device is further configured for
logging messages/events/operations performed/exchanged during provisioning; and
reporting the logged messages/events/operations performed/exchanged during the provisioning to the provisioning server.

51. The device, as claimed in claim 45, wherein the device is further configured for
generating an AuthKey; and
performing authentication with the provisioning server using the AuthKey.

52. The device, as claimed in claim 51, wherein the device is configured to generate the AuthKey by applying a Password Based Key Derivation Function using the N1, the N2, location details, prefixed string (such as “authentication key”) and the DK as inputs.

53. The device, as claimed in claim 45, wherein the device is configured to communicate directly with the provisioning server.

54. The device, as claimed in claim 45, wherein the device is configured to communicate with the provisioning server through the provisioning device.
